(19) United States
(12) Patent Application Publication
(10) Pub. No.: US 2020/0043058 A1
(43) Pub. Date: Feb. 6, 2020

(54) ADVERTISING SYSTEM AND INFORMATION PROCESSING METHOD

(71) Applicant: TOYOTA JIDOSHA KABUSHIKI KAISHA, Toyota-shi (JP)

(72) Inventors: Kazuaki TAKEMURA, Nagoya-shi (JP); Yuko MIZUNO, Nagoya-shi (JP); Kohei MUTO, Toyota-shi (JP); Keiko NAGATOMI, Toyota-shi (JP); Masatoshi KOMIYAMA, Handa-shi (JP); Kuniaki JINNAI, Nagoya-shi (JP)

(73) Assignee: TOYOTA JIDOSHA KABUSHIKI KAISHA, Toyota-shi (JP)

(21) Appl. No.: 16/458,330

(22) Filed: Jul. 1, 2019

(30) Foreign Application Priority Data
Aug. 1, 2018 (JP) 2018-145389

(51) Int. Cl. G06Q 30/02

(52) U.S. Cl. CPC G06Q 30/0273; G06Q 30/0265

(57) ABSTRACT

An advertising system comprising one or more vehicles and an information processing apparatus. The vehicle comprises a display apparatus on which an advertisement is displayed, and a first controller configured to count the number of mobile terminals that are present in the vicinity of the vehicle at a time when an advertisement is displayed on the display apparatus and to send information about the counted number of mobile terminals to the information processing apparatus, and the information processing apparatus comprises a second controller that creates fee data on the basis of information received from the vehicle, the fee data being data relating to a fee for the advertisement.

### CROSS REFERENCE TO RELATED APPLICATION

This application claims the benefit of Japanese Patent Application No. 2018-145389, filed on Aug. 1, 2018, which is hereby incorporated by reference herein in its entirety.

### BACKGROUND

### Technical Field

The present disclosure relates to technologies of providing advertisements using vehicles as media.

### Description of the Related Art

Advertising using vehicles as media has been developed in recent years. For example, an outside display apparatus is provided on a vehicle to display advertisements. The advertisement to be displayed is dynamically selected appropriately according to circumstances to optimize the effect of advertising.

Patent Literature 1 in the following citation list discloses a related technology. Specifically, Patent Literature 1 describes a system of displaying advertisements on roads that calculates the advertising fee according to expected advertising effect.

### CITATION LIST

### Patent Literature

Patent Literature 1: Japanese Patent Application Laid-Open No. 2012-168576

Patent Literature 2: Japanese Patent Application Laid-Open No. 2005-010839

### SUMMARY

When vehicles are used as media of advertising, it is not easy to estimate the effect of advertising. Some prior art systems determine the advertising fee on the basis of the amount of traffic defined in advance. Since it is not possible to count the actual number of persons present around a vehicle, a method or system for determining an appropriate advertising fee according to the actual number of persons is demanded.

The present disclosure has been made in the above circumstances, and an object of the present disclosure is to determine an appropriate fee in a system of providing advertisements using vehicles as advertising media.

An advertising system according to a first aspect of the present disclosure comprises one or more vehicles and an information processing apparatus. The vehicle comprises a display apparatus on which an advertisement is displayed and a first controller configured to count the number of mobile terminals that are present in the vicinity of the vehicle at a time when an advertisement is displayed on the display apparatus and to send information about the counted number of mobile terminals to the information processing apparatus. The information processing apparatus comprises a second controller that creates fee data on the basis of information received from the vehicle, the fee data being data relating to a fee for the advertisement.

An information processing method according to a second aspect of the present disclosure is a method implemented by an information processing apparatus and one or more vehicles having a display apparatus on which an advertisement is displayed. The information processing method comprises executing by the vehicle the first control step of counting the number of mobile terminals that are present in the vicinity of the vehicle at a time when an advertisement is displayed on the display apparatus and sending information about the counted number of mobile terminals to the information processing apparatus and executing by the information processing apparatus the second control step of creating fee data on the basis of information received from the vehicle, the fee data being data relating to a fee for the advertisement.

A non-transitory computer readable storing medium according to a third aspect of the present disclosure records a computer program for causing a computer to implement the above-described information processing method.

According to the present disclosure, the system that provides advertisement using vehicles as media can determine appropriate fees for advertisements.

### BRIEF DESCRIPTION OF THE DRAWINGS

FIG. 1 is a diagram illustrating the general configuration of an advertisement distribution system according to an embodiment.

FIG. 2 is a diagram illustrating the system configuration of a vehicle 10 according to a first embodiment.

FIG. 3 illustrates the positions of display apparatuses provided on vehicles 10.

FIG. 4 is a diagram illustrating the system configuration of a server apparatus 20 according to the first embodiment.

FIG. 5 illustrates an example of an advertisement information table stored in a database.

FIG. 6 illustrates an example of a vehicle information table stored in a database.

FIG. 7 illustrates an example of a travel record table stored in a database.

FIG. 8 is a diagram illustrating the system configuration of a mobile terminal 30 according to the first embodiment.

FIG. 9 is a flow chart of an advertisement distribution process executed by the server apparatus 20.

FIG. 10 is a flow chart of a process executed by the vehicle 10.

FIG. 11 is a flow chart of a fee data creation process executed by the server apparatus 20.

FIGS. 12A to 12D illustrate positional relationship between a vehicle 10 and a mobile terminal 30.

### DESCRIPTION OF THE EMBODIMENTS

An advertisement distribution system according to the present disclosure includes a server apparatus and a plurality of vehicles. The server apparatus distributes an advertisement to the plurality of vehicles, and the vehicles display the advertisement on their respective display apparatuses.

Each vehicle in the system according to the embodiment outputs an advertisement (in the form of a still or moving image) it has received from the server apparatus on an outside display apparatus provided on the vehicle body while it is travelling. It is desirable for the system to be capable of estimating the number of consumers who have seen the advertisement. Such consumers will be hereinafter referred to as “users”.

To this end, each vehicle that displays an advertisement in the advertisement distribution system according to the present disclosure is configured to determine or count the number of mobile terminals present in the vicinity of the vehicle at the time when an advertisement is displayed on its display apparatus and sends information about the number to the server apparatus. Then, the server apparatus creates fee data, which is data relating to a fee of the advertisement, on the basis of the information it has received from the vehicle(s).

The mobile terminals mentioned above include terminals that walking users have and/or terminals provided in vehicles which users are aboard.

The advertisement distribution system configured as above can appropriately determine a fee for advertisement by determining how many mobile terminals are present in the vicinity of the vehicle.

Further, the first controller may count the number of mobile terminals that are present in the vicinity of the vehicle and have established communication with the vehicle.

The presence of a mobile terminal can be detected by transmitting and receiving data (e.g. probe packet) for detection of the presence of a wireless communication device. Establishment of communication may include establishment of one-way data transmission.

Further, the first controller may count the number of mobile terminals that are present in an area in which the advertisement is visible.

The area in which the advertisement is visible may be, for example, an area in which there are no obstacles between the vehicle and the mobile terminals. Whether a mobile terminal is located in an area in which the advertisement is visible may be determined on the basis of the intensity of received radio waves. In cases where the mobile terminal is capable of sending information about its location, whether the mobile terminal is located in an area in which the advertisement is visible may be determined using the location information and map information.

Further, the first controller may determine positional relationship between mobile terminals and the vehicle or changes in the positional relationship and exclude mobile terminals from which the advertisement is supposed to be invisible from the count.

For example, the first controller may exclude mobile terminals located at positions relative to the vehicle from which the advertisement is not visible or mobile terminals that are moving in directions away from the vehicle.

Further, the first controller may be configured to count the number of mobile terminals every unit time. This configuration enables determination of changes in the number of mobile terminals present around the vehicle over time.

Further, the first controller may be configured to count the aforementioned number of mobile terminals for each of advertisements displayed on the display apparatus. This configuration enables determination of the fee for each advertisement.

In the following, specific embodiments of the present disclosure will be described with reference to the drawings. It should be understood that features such as hardware configurations, module configurations, and functional configurations that will be described in connection with the embodiments are not intended to limit the technical scope of the present disclosure only to them, unless otherwise stated.

### First Embodiment

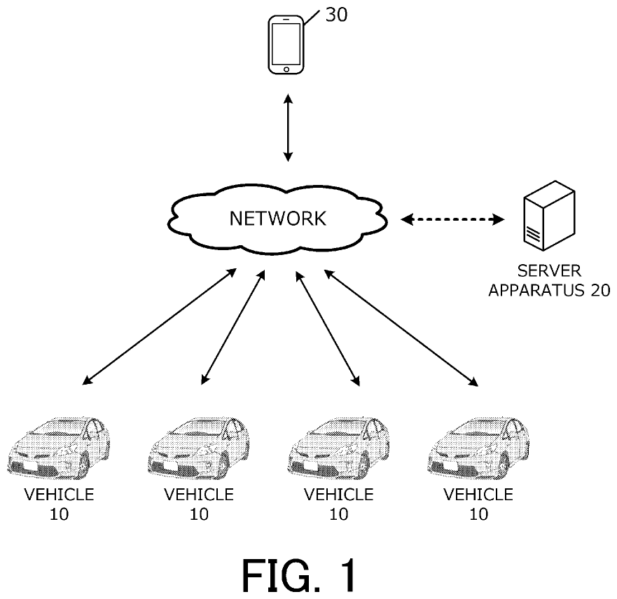

FIG. 1 illustrates the general configuration of an advertisement distribution system according to a first embodiment. The advertisement distribution system according to the first embodiment includes a plurality of vehicles 10, a server apparatus 20, and mobile terminals 30. The mobile terminal 30 may be any terminal that moves with a user. Examples of the mobile terminals 30 include terminals carried by users or terminals provided in vehicles which users are aboard. In the context of the description of this embodiment, the term “users” refer to an intended audience of an advertisement output by the vehicles 10.

The vehicle 10 is an automobile provided with a plurality of display apparatuses on the outside of its body. The vehicle 10 is capable of displaying an advertisement using advertisement data it has received from the server apparatus 20. The expression “displaying an advertisement” in the description of the embodiment means outputting image data to a display apparatus to display a still or moving image on it. The number of vehicles 10 included in the system is not limited to that in the illustrated case, but the system may include any number of vehicles 10.

The vehicle 10 receives advertisement data from the server apparatus 20 and outputs an advertisement to the display apparatuses while it is travelling. The vehicle 10 periodically sends location information and information about the advertisement displayed at the time to the server apparatus 20.

The vehicle 10 counts the number of mobile terminals present in the vicinity of the vehicle 10 while an advertisement is displayed. The result of the count is sent to the server apparatus 20.

The server apparatus 20 is a server that manages the vehicles 10 and advertisements to be displayed by the vehicles 10. The server apparatus 20 has data relating to advertising and data about the vehicles 10. The server apparatus 20 determines advertisements to be distributed to the vehicles 10, distributes advertisements to the vehicles 10, and performs management of results (e.g. makes a report to the advertiser or client).

The server apparatus 20 also manages the locations of travelling vehicles 10, records of their travel, identification data of the advertisements displayed by the vehicles 10.

The server apparatus 20 estimates the number of users that have viewed an advertisement on the basis of information sent from a vehicle(s) 10 and creates fee data associated with that advertisement.

The mobile terminal 30 is a terminal that moves with a consumer (or user). Examples of the mobile terminal 30 may include a smartphone carried by a user and a device provided in a vehicle which a user is aboard. Examples of the device include an on-vehicle computer and a navigation device. The number of mobile terminals 30 included in the system is not limited to that in the illustrated case, but the system may include any number of mobile terminals.

The vehicles 10, the server apparatus 20, and the mobile terminals 30 in the advertisement distribution system according to the embodiment are interconnected by a network. Examples of the network include a wide area network (WAN), namely a global public network, such as the Internet, and other communication networks. Examples of the network also include a telephone communication network, such as a cellular phone network, or other wireless communication networks, such as Wi-Fi (registered trademark).

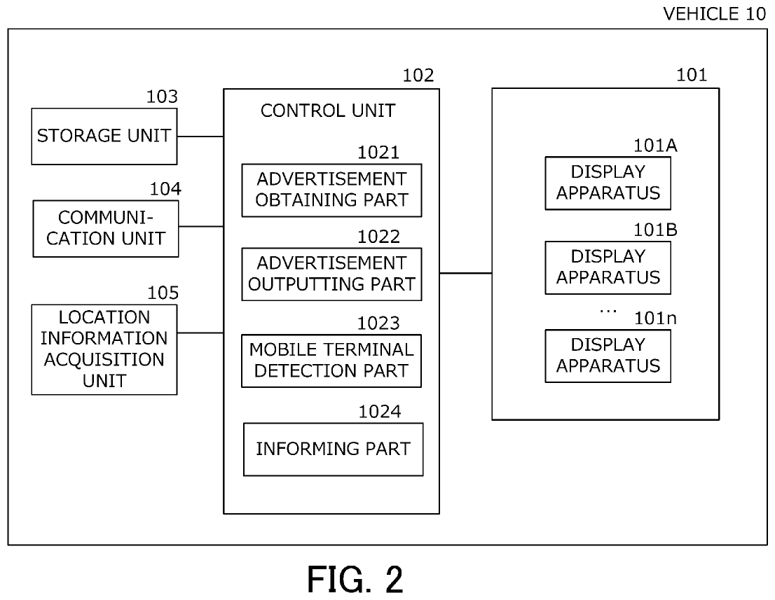

Now, the configuration of the vehicle 10 will be described. FIG. 2 is a diagram illustrating the system configuration of the vehicle 10.

The vehicle 10 includes a display unit 101, a control unit 102, a storage unit 103, a communication unit 104, and a location information acquisition unit 105.

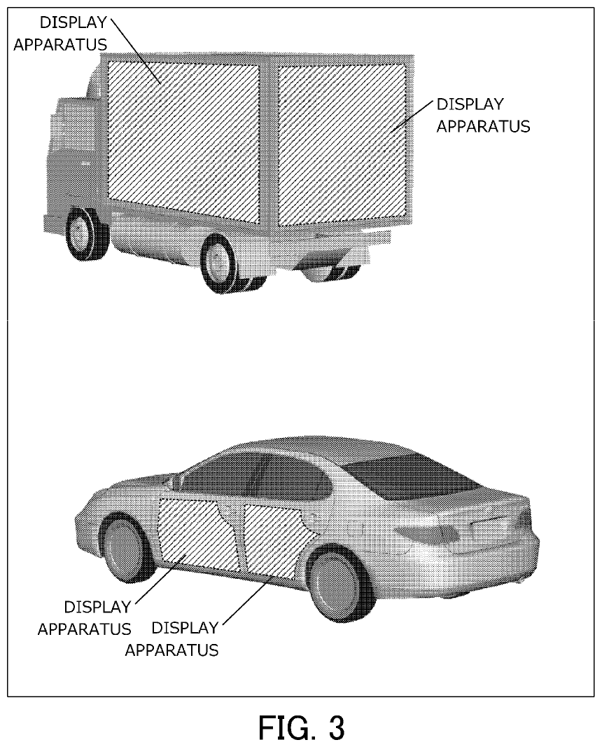

The display apparatus 101 includes a plurality of display apparatuses provided on the outside of the vehicle 10. As illustrated in FIG. 3, the vehicle 10 in the system according to the embodiment has a plurality of display apparatuses 101A, 101B, . . . , 101n that face outward. The display apparatuses will be collectively designated as the display apparatus 101, where identification of individual display apparatuses is not necessary.

The display apparatus 101 may be a liquid crystal display, an organic electroluminescence display, an LED matrix, or a projector.

The number of display apparatuses provided on one vehicle 10 varies depending on the type or model of the vehicle 10. Display apparatuses may be provided on different portions of the vehicle 10, for example, on the right and left sides, the rear, and the top of the vehicle. For example, a truck may have three display apparatuses provided on the right side, the left side, and the rear of the vehicle. A sedan may have four display apparatuses provided on the front door on the left side, the rear door on the left side, the front door on the right side, and the rear door on the right side.

Display apparatuses 101 may be provided at positions other than those described above. For example, if it is possible to project images on a sheet of glass, display apparatuses may be provided on windows (e.g. side and rear windows).

Control unit 102 is a computing device that controls the function of outputting advertisements among the functions of the vehicle 10. The control unit 102 may be implemented by a computational processing unit, such as a CPU (Central Processing Unit).

The control unit 102 includes four functional modules, which include an advertisement obtaining part 1021, an advertisement outputting part 1022, a mobile terminal detection part 1023, and an informing part 1024. These functional modules may be implemented by executing programs stored in the storage unit 103 (described later) by a CPU.

The advertisement obtaining part 1021 obtains data (advertisement data) relating to an advertisement to be output on the display apparatus 101 from the server apparatus 20. It is preferred that the advertisement data be obtained just before the vehicle 10 starts to travel or while the vehicle 10 is travelling, though the timing of obtaining the advertisement data is not limited to these. The advertisement data may be obtained at the time when the ignition is turned on, when a destination is set, or when the vehicle 10 starts to travel. The advertisement data obtained by the advertisement obtaining part 1021 is stored in the storage unit 103, which will be described later.

The advertisement outputting part 1022 outputs an advertisement contained in the advertisement data to the display apparatus 101. A condition for outputting the advertisement may be specified in the advertisement data, and the advertisement may be output only when the condition is met. The advertisement data may designate the position and the size of the display apparatus, and the advertisement outputting part 1022 may output the advertisement according to the designations.

The mobile terminal detection part 1023 detects mobile terminals 30 present around the vehicle 10 and counts the number of them. Detection of mobile terminals 30 may be carried out in either an active mode or a passive mode. In the active mode, each mobile terminal 30 broadcasts a packet to notify the presence thereof. In the passive mode, the vehicle 10 broadcasts a packet to search for mobile terminals 30, and the mobile terminals 30 that have received the packet respond to it. In the following description, a packet that is transmitted and received for the purpose of detection of a mobile terminal(s) 30 will be referred to as “probe packet”.

For example, in the case of a mobile terminal 30 capable of performing communication using a wireless LAN, the mobile terminal detection part 1023 can detect the presence of the mobile terminal 30 by receiving a probe request sent from the mobile terminal 30.

The type of the packet used in detection of a mobile terminal 30 may be selected in conformity with the communication standard used.

The informing part 1024 sends information about display of an advertisement to the server apparatus 20. Specifically, the informing part 1024 collects information about the present location of the vehicle, identification data of the advertisement presently displayed, information about the number of mobile terminals counted by the mobile terminal detection part 1023, and other information relating to the advertisement and sends them to the server apparatus 20.

Details of processing executed by each module will be described later.

The storage unit 103 includes a main storage device and an auxiliary storage device. The main storage device is a memory into which programs executed by the control unit 102 and data used by such control programs are loaded. The auxiliary storage device is a device in which the programs executed by the control unit 102 and the data used by the control programs are stored. An operating system for executing the programs may also be stored in the auxiliary storage device. Programs stored in the auxiliary storage device are loaded into the main storage device and executed by the control unit 102 to implement the aforementioned functions.

The communication unit 104 is a wireless communication interface that connects the vehicle 10 to the network. The communication unit 104 provides access to the network via, for example, a wireless LAN or a mobile communication service based on 3G or LTE.

The location information acquisition unit 105 is a unit configured to acquire location information of the vehicle 10. The location information acquisition unit 105 includes, for example, a GPS module and acquires location information (e.g. latitude and longitude) of the vehicle 10.

FIG. 2 is given only to illustrate an exemplary configuration, and all or some of the functions shown in FIG. 2 may be implemented by circuits dedicated to the functions. Main and auxiliary storage devices other than those illustrated may be employed in combination to store and/or execute programs.

Next, the configuration of the server apparatus 20 will be described.

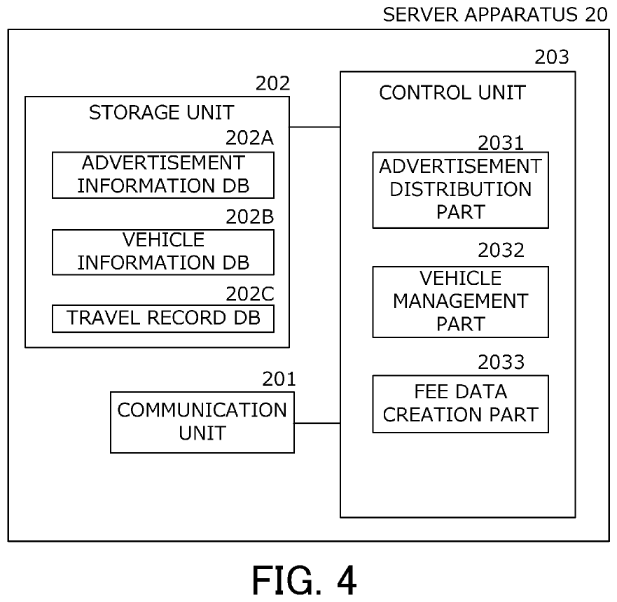

FIG. 4 is a diagram illustrating the system configuration of the server apparatus 20. The server apparatus 20 includes a communication unit 201, a storage unit 202, and a control unit 203.

The server apparatus 20 is constituted by an ordinary computer. Specifically, the server apparatus 20 is a computer including a processor(s), such as a CPU and/or a GPU, a main storage device(s), such as a RAM and/or a ROM, and an auxiliary storage device(s), such as an EPROM, a hard disk drive and/or a removable medium. Examples of the removable medium include a USB memory and a recording disc medium, such as a CD or DVD. What is stored in the auxiliary storage device includes an operating system (OS), various programs, and various tables. The programs stored in the auxiliary storage device are loaded into a workspace of the main storage device and executed to control various components, thereby providing appropriate functions for achieving desired purposes, which will be described later. All or some of the functions may be implemented by a hardware circuit, such as an ASIC or an FPGA. The server apparatus 20 may be constituted by a single computer or a plurality of computers that work in cooperation with each other.

The communication unit 201 is a communication interface that connects the server apparatus 20 to the network. The communication unit 201 includes, for example, a network interface board and a wireless communication circuit for achieving wireless communication.

The storage unit 202 includes a main storage device and an auxiliary storage device. The main storage device is a memory into which programs executed by the control unit 203 and data used by such control programs are loaded. The auxiliary storage device is a device in which the programs executed by the control unit 203 and the data used by the control programs are stored. The main storage device and the auxiliary storage device are similar to those in the storage unit 103 and will not be described in further detail.

What is stored in the storage unit 202 also includes an advertisement information database 202A, a vehicle information database 202B, and a travel record data base 202C.

The advertisement information database 202A is a database in which data relating to advertisements to be distributed to the vehicles 10 is stored. Such data is created by an advertiser(s).

The vehicle information data base 202B is a database in which properties and characteristics of the vehicles 10 are stored. Such data is created when the vehicles 10 are registered in the system.

The travel record database 202C is a database in which records of travel of the vehicles 10 are stored. The record of travel includes, for example, a route or locations that the vehicle 10 has travelled, the status of display of an advertisement, and identification data of the displayed advertisement. The stored data is updated on the basis of information collected from the vehicles 10.

These databases are created by managing data stored in the storage device by a database management system program (DBMS program) executed by the processor. The databases used in the system according to the embodiment are, for example, relational databases.

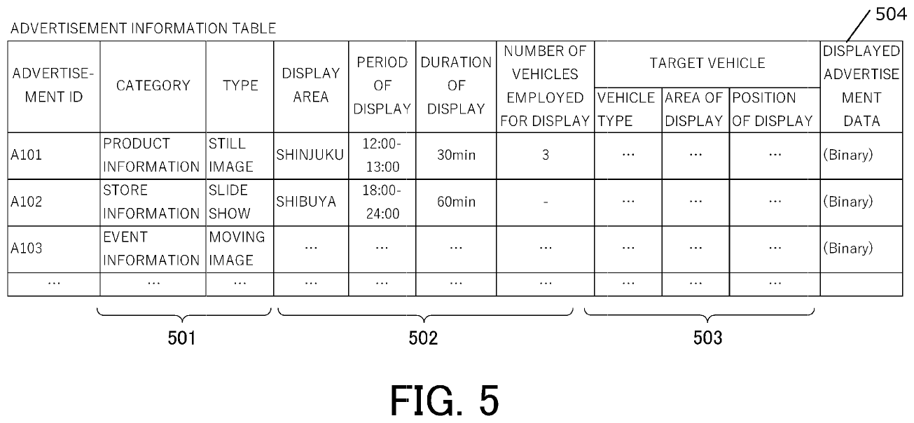

Data stored in the advertisement information database 202A will now be described with reference to FIG. 5. FIG. 5 illustrates an example of the content of an advertisement information table stored in the advertisement information database 202A. As illustrated, the information stored in the advertisement information table includes information relating to properties of the advertisement (501), information relating to conditions for display of the advertisement (502), information designating a vehicle to be employed to display the advertisement (503), and data to be output to the display apparatus 101 of the vehicle (504). The data stored in the advertisement information database 202A will be referred to as “advertisement data”.

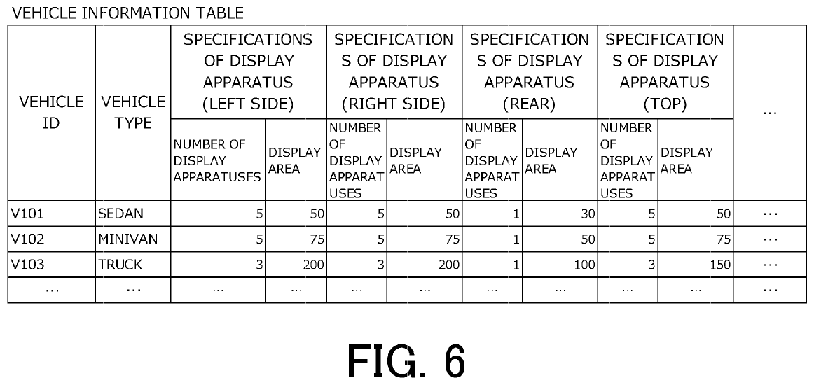

Next, data stored in the vehicle information database 202B will be described with reference to FIG. 6. FIG. 6 illustrates an example of the content of a vehicle information table stored in the vehicle information database 202B. The information stored in the vehicle information table includes information about the type of the vehicle and information about the display apparatus. Examples of the information about the display apparatus include, but are not limited to, the positions at which the display apparatuses are provided, the number of panels in each position, and the area of each display.

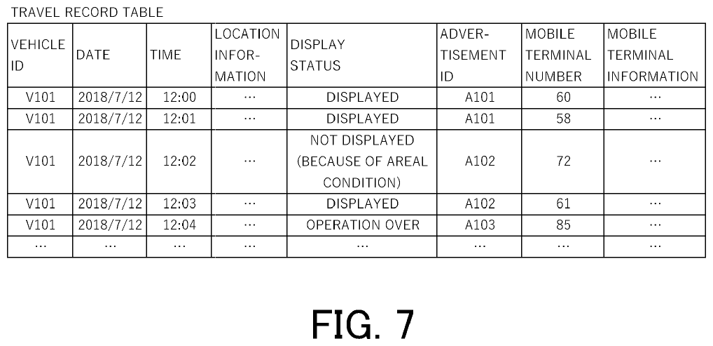

Data stored in the travel record database 202C will be described with reference to FIG. 7. FIG. 7 illustrates an example of the content of a travel record table stored in the travel record database 202C. Information stored in the travel record table includes identification data of the vehicle (VEHICLE ID), date and time, location information (e.g. latitude and longitude) of the vehicle 10, the status of display of advertisement (DISPLAY STATUS), identification data of the displayed advertisement (ADVERTISEMENT ID), the number of mobile terminals 30 detected in the vicinity of the vehicle (MOBILE TERMINAL NUMBER), and specific information about the detected mobile terminals 30 (MOBILE TERMINAL INFORMATION).

The display status is information indicating the status of display of advertisement, examples of which include “DISPLAYED”, “NOT DISPLAYED”, “PARKED”, and “OPERATION OVER” (indicating that the operation has ended). When the display of advertisement is not performed for some reason, such as that the vehicle 10 is travelling outside the area designated by the advertiser or the time of travel does not fall in the designated time period, the display status may include the reason.

The mobile terminal number is the number of mobile terminals 30 detected in the vicinity of the vehicle 10.

The mobile terminal information is a list of detailed information about the detected mobile terminal 30 (e.g. the type or identification data of the terminal). This information is used, for example, to find duplication of the same terminal.

How the data stored in the databases is used will be described later.

The control unit 203 is a computing unit that executes control performed by the server apparatus 20. The control unit 203 may be implemented by a computational processing unit, such as a CPU.

The control unit 203 includes as functional modules an advertisement distribution part 2031, a vehicle management part 2032, and a fee data creation part 2033. These three functional modules may be implemented by executing programs stored in the auxiliary storage device by the CPU.

The advertisement distribution part 2031 determines advertisements to be displayed by respective vehicles 10 and sends corresponding advertisement data to the vehicles 10.

The vehicle management part 2032 periodically communicates with the vehicles 10 to collect location information of the vehicles 10 and identification data of the advertisements displayed by the vehicles 10 and updates the travel record database 202C.

The fee data creation part 2033 creates data relating to a fee for the displayed advertisement (fee data). Specifically, the fee data creation part 2033 estimates the number of users who have seen the advertisement on the basis of information recorded in the travel record database 202C and creates fee data on the basis of the estimated number of users.

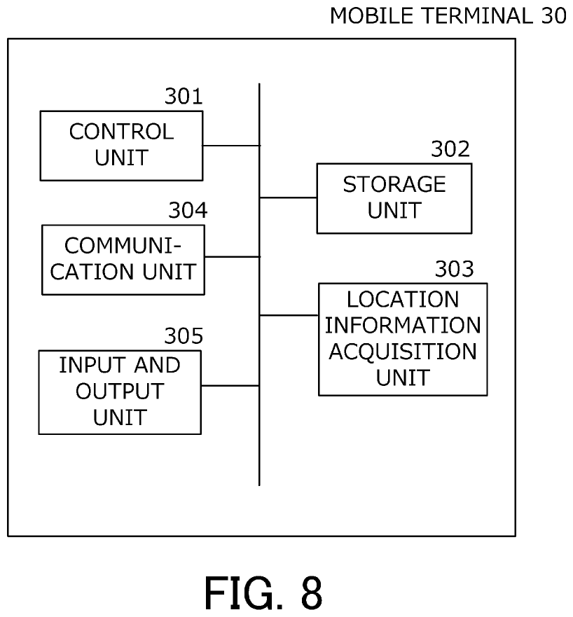

Next, the configuration of the mobile terminal 30 will be described. FIG. 8 is a diagram illustrating the system configuration of the mobile terminal 30.

The mobile terminal 30 is a small computer, such as a smartphone, a cellular phone, a tablet computer, a personal information terminal, a laptop personal computer, a wearable computer (e.g. smartwatch), or an on-vehicle terminal provided on a vehicle. The mobile terminal 30 includes a control unit 301, a storage unit 302, a location information acquisition unit 303, a communication unit 304, and an input and output unit 305.

The control unit 301 is a computing unit that executes control performed by the mobile terminal 30. The control unit 301 may be implemented by a computational processing unit, such as a CPU (Central Processing Unit).

The control unit 301 executes the functions of sending a probe packet notifying the presence thereof to the vehicle 10 or responding to a probe packet sent from the vehicle 10.

Details of its processing will be described later.

The storage unit 302 includes a main storage device and an auxiliary storage device. The main storage device is a memory into which programs executed by the control unit 301 and data used by such control programs are loaded. The auxiliary storage device is a device in which the programs executed by the control unit 301 and the data used by the control programs are stored. A package of application programs executed by the control unit 301 may be stored in the auxiliary storage device. An operating system for executing the application programs may also be stored in the auxiliary storage device. Programs stored in the auxiliary storage device are loaded into the main storage device and executed by the control unit 301 to execute processing described in the following.

The main storage device may include a RAM (Random Access Memory) and/or a ROM (Read Only Memory). The auxiliary storage device may include an EPROM (Erasable Programmable ROM) and/or a hard disk drive (HDD). The auxiliary storage device may also include a removable medium, namely portable recording medium. Examples of the removable medium include a USB memory (Universal Serial Bus memory) and a recording disc medium, such as a CD (Compact Disc) or a DVD (Digital Versatile Disc).

The location information acquisition unit 303 is a unit configured to acquire location information of the mobile terminal 30. The location information acquisition unit 303 includes, for example, a GPS module and acquires location information (e.g. latitude and longitude) of the mobile terminal 30.

The communication unit 304 is a wireless communication interface that connects the mobile terminal to the network. The communication unit 304 provides access to the network via, for example, a wireless LAN or a mobile communication service based on 3G or LTE.

The input and output unit 305 is a unit configured to receive input operations by a user and provide information to the user. The input and output unit 305 of the mobile terminal 30 according to the embodiment is constituted by a single touch-panel display, which includes a liquid crystal display, its control unit, a touch panel, and its control unit.

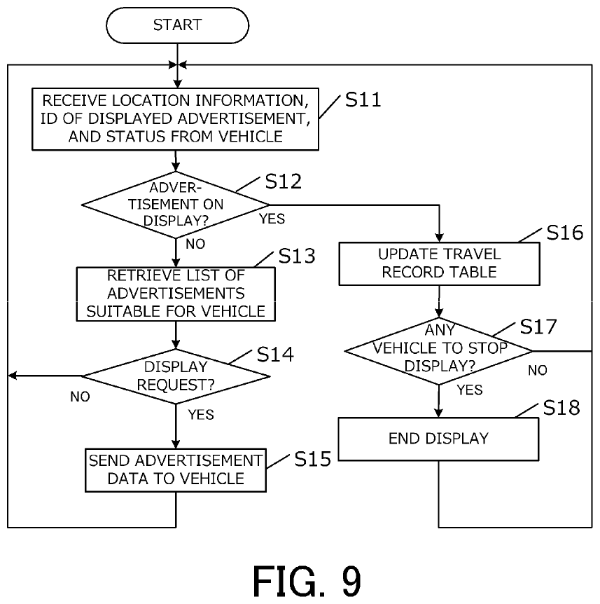

The advertisement distribution system according to the embodiment distributes advertisements to the vehicles 10 to let them display the advertisements. The process of distributing and displaying advertisements will now be described. FIG. 9 is a flow chart of a process executed by the server apparatus 20. The management server 20 executes the process illustrated in FIG. 9 periodically (every unit time) for each of the vehicles 10 under its management.

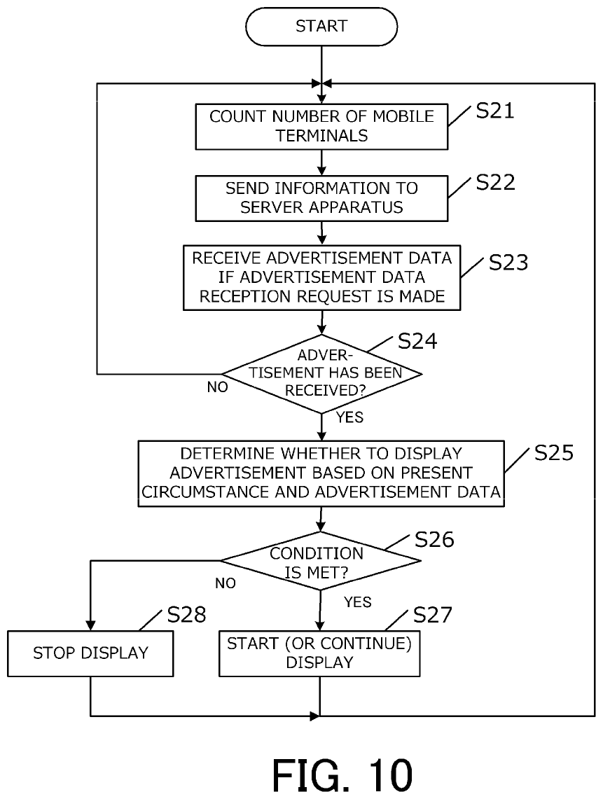

Firstly in step S11, the server apparatus 20 collects from the vehicles 10 under its management location information, the identification data of the presently displayed advertisement, and the status of display of advertisement. Specifically, the vehicle management part 2032 sends an inquiry to each of the vehicles 10 (specifically, the informing part 1024 thereof), and the informing part 1024 of each vehicle 10 sends location information acquired by the location information acquisition unit 105 in response to the inquiry. The informing part 1024 also sends information about whether or not there is an advertisement presently on display (with the ID of the advertisement, if affirmative) and the status of display of advertisement. The informing part 1024 also sends information about the number of mobile terminals 30 counted by the mobile terminal detection part 1023 and information about the mobile terminals 30. Details of the process executed by the vehicles 10 will be described later with reference to FIG. 10.

While in the system according to the embodiment the server apparatus 20 periodically sends an inquiry to the vehicle 10, the vehicle 10 may periodically send the aforementioned information to the server apparatus 20 by push communication alternatively. In this alternative case, the processing of step S11 may be executed at a point in the process different from that in FIG. 9

Then, in step S12, the advertisement distribution part 2031 determines whether or not the subject vehicle 10 (namely, the vehicle for which this process is being performed) is presently displaying an advertisement. If a negative determination is made, the process proceeds to step S13, where the advertisement distribution part 2031 retrieves one or more advertisements that the vehicle 10 can display.

Whether or not there are advertisements that a certain vehicle 10 can display can be determined by whether the properties of the vehicle 10 meet the condition set for each advertisement. For example, in the case where a condition relating to the type of the vehicle and its display apparatus is set for an advertisement as shown in columns 503 in the table in FIG. 5, whether or not the advertisement can be displayed is determined by whether or not the properties of the vehicle 10 meet the condition.

If there is an advertisement(s) for which the subject vehicle 10 meets the condition, information relating to the advertisement(s) is extracted and stored temporarily.

A determination as to whether or not conditions relating to the area and time among the conditions set for an advertisement are met is not made in this step. This is because whether such conditions are met or not changes depending on the state of travel of the vehicle 10. This determination is made by the vehicle 10 to which the advertisement has been distributed, and whether or not the advertisement can be displayed is determined by the vehicle 10. If it is apparent that a condition set for an advertisement will not be met, that advertisement may be excluded in this step.

Then, in step S14, it is determined whether or not a request for display of the advertisement(s) is to be made to the subject vehicle 10. For example, if one or more advertisements were extracted in step S13, an affirmative determination is made in this step. Then, in step S15, advertisement data associated with the extracted advertisement(s) is sent to the subject vehicle 10.

If an affirmative determination is made in step S12, it means that the subject vehicle 10 has already been travelling while displaying a certain advertisement. Then, in step S16, the travel record table is updated using the location information and the advertisement ID received from the vehicle 10. Specifically, the vehicle management part 2032 adds a record containing the vehicle ID, the date and time, the location information, the status, the ID of the displayed advertisement, the number of mobile terminals, and information about the mobile terminals to the travel record table stored in the travel record database 202C.

Then, in step S17 it is determined whether or not there is a vehicle(s) that is to stop displaying the advertisement. In this step, it is determined whether or not there is an advertisement(s) for which the condition for ending the display is met on the basis of information received from the vehicles 10. For example, in the case where a total display time is designated for a certain advertisement, if the total display time of this advertisement has elapsed, it is determined that the display of this advertisement is to be ended. Furthermore, if the operation (or travel) of a vehicle 10 that displays a certain advertisement ends (e.g. if the ignition is turned off), it is determined that the display of this advertisement is to be ended.

If an affirmative determination is made in step S17, the process proceeds to step S18, where the display of advertisement by the pertinent vehicle(s) is ended. Specifically, the advertisement distribution part 2031 sends a command to end the display of advertisement to the pertinent vehicle(s) 10.

The above-described process is executed repeatedly for every vehicle 10 under the management of the server apparatus 20.

Next, a process executed by the vehicle 10 will be described.

FIG. 10 is a flow chart of a process executed by the vehicle 10. The process illustrated in FIG. 10 is executed by the vehicle 10 upon reception of the inquiry from the server apparatus 20.

Firstly in step S21, in response to the inquiry from the server apparatus 20, the mobile terminal detection part 1023 detects mobile terminals 30 present in the vicinity of the vehicle 10 and counts the number of them.

The detection of mobile terminals 30 may be carried out by, for example, broadcasting a probe packet and receiving response packets sent in response to the probe packet. Alternatively, the detection of mobile terminals may be carried out by receiving probe packets that mobile terminals 30 have sent on their own initiative.

The type of the broadcast packet may be selected in conformity with a communication standard that the mobile terminals 30 can use. For example, the mobile terminals 30 may use a wireless LAN (IEEE802.11), Wi-Fi (registered trademark) direct, C-V2X, DSRC, or Bluetooth (registered trademark) Low Energy.

When counting the number of mobile terminals 30, the mobile terminal detection part 1023 may use identification data included in the packets sent from the mobile terminals 30 to exclude duplication.

Then, in step S22, in response to the inquiry from the server apparatus 20, the informing part 1024 sends the following information to the server 20:
(1) location information acquired by the location information acquisition unit 105
(2) the presence/absence of displayed advertisement (with its ID, if present)
(3) the status of display of advertisement
(4) the number of mobile terminals detected in step S21 and detailed information of the detected mobile terminals (e.g. a list of identification data thereof)

While in the system according to this embodiment the vehicle 10 sends information in response to the inquiry sent from the server apparatus 20, the vehicles 10 may send the aforementioned information to the server apparatus 20 at predetermined intervals by push communication alternatively. In this alternative case, the processing of steps S21 and S22 is not necessarily executed at the timing indicated in FIG. 10.

Then, in step S23, it is determined whether or not reception of advertisement data is requested by the server apparatus 20, and if it is requested the vehicle 10 receives the advertisement data.

Then, in step S24, it is determined whether or not the advertisement outputting part 1022 has already received the advertisement data from the server apparatus 20. If a negative determination is made in step S24, the process returns to step S21. If an affirmative determination is made in step S24, the process proceeds to step S25, where it is determined whether or not the advertisement is to be displayed on the basis of comparison between the present circumstance and the condition set in the advertisement data.

For example, if it is designated in the advertisement data that the advertisement should be displayed only in a designated area, whether the advertisement is to be displayed or not is determined on the basis of the result of comparison of the condition relating to the area and the location information acquired by the location information acquisition unit 105. If it is designated in the advertisement data that the advertisement should be displayed only in a designated time period, whether the advertisement is to be displayed or not is determined on the basis of the result of comparison of the condition relating to the time period and the present date and time.

While area and time period are given as examples of conditions for determining whether the advertisement is to be displayed or not, other conditions based on which the vehicle 10 can make the determination may be set.

If the result of determination in step S25 indicates that the condition is met (Yes in step S26), the process proceeds to step S27, where display of the advertisement is started (or continued, if the advertisement has already been displayed). If the condition is not met (No in Step S26), the process proceeds to step S28, where display of the advertisement is ended.

The vehicle 10 displays the advertisement by the above process.

Next, a process performed by the server apparatus 20 to determine a fee for an advertisement will be described. In this process, the server apparatus 20 determines the fee on the basis of information stored in the travel record database 203C. Specifically, the system according to this embodiment determines a fee for an advertisement on the basis of the actual result after the display of the advertisement.

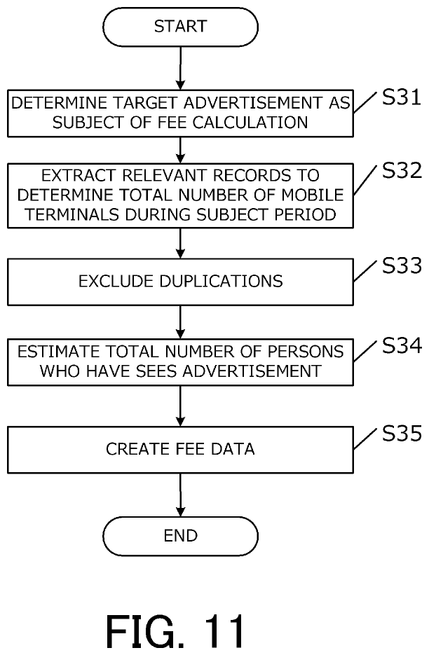

FIG. 11 is a flow chart of a process executed by the server apparatus 20 to determine a fee for an advertisement. This process may be executed at a specific time. For example, it may be executed after the lapse of the period over which the advertisement is displayed or executed repeatedly (e.g. every day or every several hours) during the period over which the advertisement is displayed.

Firstly in step S31, an advertisement for which a fee is to be calculated is determined. This advertisement will be hereinafter referred to as the “subject advertisement”. Then, in step S32, records associated with the subject advertisement are extracted from the travel record table to determine the total number of mobile terminals 30 detected during the period for which a fee is to be calculated. For example, if the period for which a fee is to be calculated (subject period) is the period from 12:00 to 12:04 in the case shown in FIG. 7, the total number of mobile terminals 30 is 336 (=60+58+72+61+85).

Then, in step S33, duplications of mobile terminals 30 are excluded. Specifically, if information (e.g. identification data of mobile terminals 30) stored in the travel record table (specifically, the mobile terminal information field) indicates the same terminal detected at different but close locations and times, it is determined that there is a duplication. Then, the count of terminals is decreased by the number of duplications.

Then, in step S34, the total number of persons considered to have seen the subject advertisement is estimated on the basis of the number of mobile terminals 30 after exclusion of duplications. The number of persons may be estimated by multiplying the number of mobile terminals 30 by a specific coefficient that is varied among models of mobile terminals. This coefficient is used to provide a correction for difference between the actual number of persons and the number of persons in possession of a mobile terminal 30.

Then, in step S35, a fee for the advertisement over the subject period is determined on the basis of the estimated number of persons, and fee data is created.

In the above case, the total number of mobile terminals 30 detected during a subject period is counted, and thereafter duplications are excluded. Alternatively, the average number of terminals per unit time may be calculated. For example, in the case shown in FIG. 7, the average number of terminals 30 over five minutes is 67. Since the numbers of mobile terminals 30 in the respective time slots do not overlap, the process of excluding duplications of mobile terminals 30 can be eliminated.

As above, the system according to the first embodiment estimates the number of users who have seen an advertisement on the basis of data obtained by communication between the vehicles 10 that have displayed the advertisement and mobile terminals 30. This enables calculation of an appropriate fee for the advertisement.

While in the above described embodiment a fee for an advertisement is calculated on the basis of the number of users who are considered to have seen the advertisement, it may be determined taking account of other additional factors. For example, the fee may be adjusted based on places or route the vehicles 10 have travelled. Alternatively, an additional fee may be charged according to the number of times of interaction initiated by users (e.g. access to an electronic medium).

Further, if the vehicle 10 is provided with a camera, the fee may be adjusted using information obtained by analyzing images captured by the camera (e.g. the amount of traffic around the vehicle 10, the number of pedestrians, and the line of sight of pedestrians etc.).

### Second Embodiment

In the system according to the first embodiment, the vehicle 10 counts all the mobile terminals 30 present in an area in which communication with the vehicle 10 is possible. The system according to the second embodiment is configured to count only the mobile terminals 30 present in an area in which the advertisement is visible.

In the system according to the second embodiment, when the mobile terminal detection part 1023 counts the number of mobile terminals 30 in step S21 in the above-described process, it counts only the mobile terminals 30 present at locations from which the advertisement is visible. Whether or not a mobile terminal 30 is at a location from which the advertisement is visible can be determined by, for example, whether or not the distance between the vehicle 10 and the mobile terminal 30 is shorter than a predetermined distance. The distance between the vehicle 10 and the mobile terminal 30 may be estimated from the intensity of received radio waves or calculated using location information of the mobile terminal 30 if it is capable of sending location information.

The visibility of an advertisement may be determined on the basis of only the distance or the distance and other additional information.

For example, the vehicle 10 having received location information from the mobile terminal 30 may determine whether or not the mobile terminal 30 is located within the visible distance from the vehicle 10 using the location information and map information the vehicle has.

While in the above described case the determination as to whether or not a mobile terminal 30 is at a location from which the advertisement is visible is made by the vehicle 10, the server apparatus 20 may make this determination alternatively. In this alternative case, information about the location of the mobile terminal 30 may be stored in the mobile terminal information field of the travel record table, when the travel record table is updated. Then, in step S32, mobile terminals 30 that do not meet a condition may be excluded.

As above, the system according to the second embodiment counts only the mobile terminals 30 located in an area in which the advertisement is visible. This improves calculation of an appropriate fee for the advertisement.

### Third Embodiment

In the system according to the first embodiment, the vehicle 10 counts all the mobile terminals 30 present in an area in which communication with the vehicle 10 is possible. The system according to the third embodiment is configured to perform filtering of mobile terminals 30 based on positional relationship between the vehicle 10 and the mobile terminals 30 when counting them.

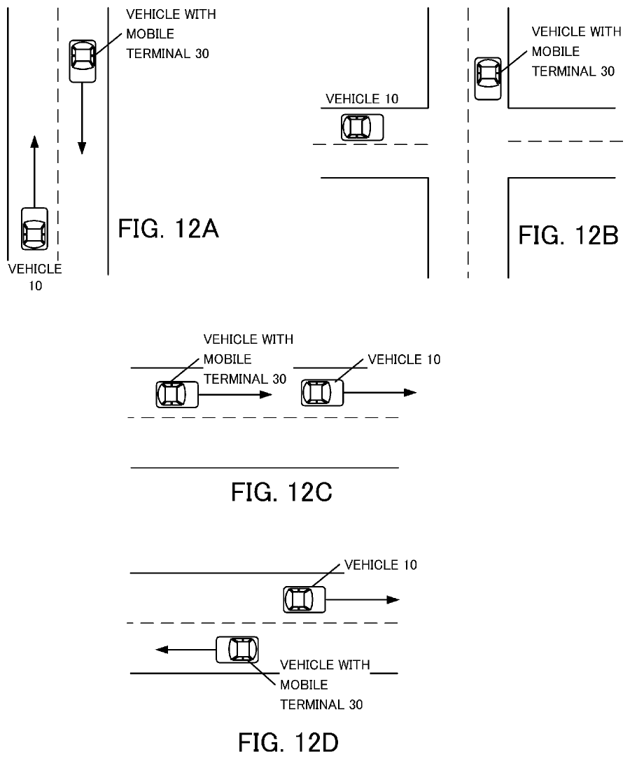

FIGS. 12A to 12D illustrates positional relationship between a vehicle 10 in the system and a vehicle provided with a mobile terminal 30. When the vehicle 10 and a mobile terminal 30 are moving closer to each other as illustrated in FIGS. 12A and 12B, it is probable that the user associated with this mobile terminal 30 can see the advertisement displayed by the vehicle 10. This is also the case when the vehicle 10 and a mobile terminal 30 are moving while keeping a certain distance between them as illustrated in FIG. 12C. On the other hand, when the vehicle 10 and a mobile terminal 30 are moving away from each other as illustrated in FIG. 12D, the user associated with this mobile terminal 30 cannot see the advertisement.

In the system according to the third embodiment, the vehicle 10 determines whether or not to count a mobile terminal 30 by whether the mobile terminal 30 is moving in a direction away from the vehicle 10 (in step S21).

The direction in which the mobile terminal 30 is moving may be determined using location information received from the mobile terminal 30. For this purpose, the mobile terminal 30 may include its location information in the probe packet it sends. Alternatively, the probe packet that the mobile terminal 30 sends may include information about the direction of movement.

As above, the system according the third embodiment does not count mobile terminals 30 present around the vehicle 10 unconditionally.

While in the above described case the direction of movement of a mobile terminal 30 is determined by the vehicle 10, the server apparatus 20 may determine the direction alternatively. In this alternative case, information about the direction of movement of the mobile terminal 30 may be stored in the mobile terminal information field of the travel record table, when the travel record table is updated. Then, in step S32, mobile terminals 30 that do not meet a condition may be excluded.

While the system according to the third embodiment determines whether or not to count a mobile terminal 30 on the basis of changes in positional relationship with the vehicle 10, the system may determine this simply on the basis of positional relationship with the vehicle 10. For example, if the vehicle 10 has a display apparatus only on one side, the vehicle 10 may exclude a mobile terminal 30 from count when the mobile terminal 30 is located on the side opposite to the display apparatus.

### Modifications

The above embodiments are only for the illustrative purpose. Appropriate modifications can be made thereto without departing from the essence of the present disclosure.

While the systems according to the embodiments create only fee data for an advertisement, the systems may be configured to subtract calculated fees from a predetermined advertisement budget amount and to stop display of advertisement when the remaining amount becomes zero.

The processing and means that have been described in the foregoing may be employed in any combinations so long as it is technically feasible to do so.

A process described to be performed by one apparatus may be performed by a plurality of apparatuses in a distributed manner. A process described to be performed by different apparatuses may be performed by a single apparatus. The hardware configuration (or server configuration) employed to implement the functions of a computer system may be modified flexibly.

The present disclosure can be carried out by supplying a computer program(s) that implements the functions described in the above description of the embodiments to a computer to let one or more processors of the computer read and execute the program(s). Such a computer program(s) may be supplied to the computer by a computer-readable, non-transitory storage medium that can be connected to a system bus of the computer, or through a network. Examples of the computer-readable, non-transitory storage medium include any type of disc medium including, a magnetic disc, such as a floppy (registered trademark) disc and a hard disk drive (HDD), and an optical disc, such as a CD-ROM, a DVD disc and a Blu-ray disc, a read-only memory (ROM), a random access memory (RAM), an EPROM, an EEPROM, a magnetic card, a flash memory, an optical card, and any type of medium suitable for storage of electronic commands.

What is claimed is:

1. An advertising system comprising one or more vehicles and an information processing apparatus,
the vehicle comprising:
a display apparatus on which an advertisement is displayed, and
a first controller configured to count the number of mobile terminals that are present in the vicinity of the vehicle at a time when an advertisement is displayed on the display apparatus and to send information about the counted number of mobile terminals to the information processing apparatus, and
the information processing apparatus comprising:
a second controller that creates fee data on the basis of information received from the vehicle, the fee data being data relating to a fee for the advertisement.

2. An advertising system according to claim 1, wherein
the first controller counts the number of mobile terminals that are present in the vicinity of the vehicle and have established communication with the vehicle.

3. An advertising system according to claim 2, wherein
the first controller counts the number of mobile terminals that are present in an area in which the advertisement is visible.

4. An advertising system according to claim 2, wherein
the first controller determines positional relationship between the mobile terminals and the vehicle and exclude mobile terminals from which the advertisement is supposed to be invisible from the count.

5. An advertising system according to claim 2, wherein
the first controller determines changes in positional relationship between mobile terminals and the vehicle and exclude mobile terminals from which the advertisement is supposed to be invisible from the count.

6. An advertising system according to claim 1, wherein
the first controller counts the number of mobile terminals every unit time.

7. An advertising system according to claim 1, wherein
the first controller counts the number of mobile terminals for each of advertisements displayed on the display apparatus.

8. An advertising system according to claim 1, wherein
the mobile terminals are terminals carried by walkers or terminals provided in vehicles.

9. An information processing method implemented by an information processing apparatus and one or more vehicles having a display apparatus on which an advertisement is displayed, comprising:
executing by the vehicle the first control step of counting the number of mobile terminals that are present in the vicinity of the vehicle at a time when an advertisement is displayed on the display apparatus and sending information about the counted number of mobile terminals to the information processing apparatus; and
executing by the information processing apparatus the second control step of creating fee data on the basis of information received from the vehicle, the fee data being data relating to a fee for the advertisement.
